(19) United States
(12) Patent Application Publication
(10) Pub. No.: US 2026/0148382 A1
(43) Pub. Date: May 28, 2026

(54) DIGITAL HISTOPATHOLOGY IMAGE ANALYSIS USING TISSUE MICROARRAYS

(71) Applicant: Janssen Research & Development, LLC, Raritan, NJ (US)

(72) Inventors: Erik Burlingame, Raritan, NJ (US); Albert Juan Ramon, San Diego, CA (US); Fatemeh Koochakighermezcheshme, Raritan, NJ (US); Tsun-Wen Sheena Yao, Raritan, NJ (US); Shajo Kunnath-Velayudhan, Raritan, NJ (US); Kristopher Standish, San Diego, CA (US)

(73) Assignee: Janssen Research & Development, LLC, Raritan, NJ (US)

(21) Appl. No.: 19/399,398

(22) Filed: Nov. 24, 2025

Related U.S. Application Data
(60) Provisional application No. 63/724,870, filed on Nov. 25, 2024.

(51) Int. Cl. G06T 7/00; G01N 1/30; G06V 10/764; G06V 10/766; G06V 10/774

(52) U.S. Cl. CPC G06T 7/0012; G01N 1/30; G06T 2200/24; G06T 2207/20081; G06T 2207/20084; G06T 2207/30024; G06T 2207/30096; G06T 2207/30204; G06V 10/764; G06V 10/766; G06V 10/774; G06V 2201/03

(57) ABSTRACT

In some embodiments, tissue microarray (TMA) core images are used to train a deep learning network that can then be deployed to computer inferences regarding whole tissue section (WTS) images (WSIs). Preprocessing aligns paired serial core images from differently stained core sections with their associated metadata and H-scores (or other label data obtained from evaluating one of the paired core sections). In some embodiment, a self-supervised learning (SSL) pre-trained encoder is used to generate patch-level embeddings from TMA core images associated with corresponding labels that are then used to train an attention-based deep learning network to generate inferences. These and other aspects of the present disclosure are more fully detailed herein.

### CROSS-REFERENCE TO RELATED APPLICATIONS

This application claims the benefit of U.S. Provisional Application No. 63/724,870, filed on Nov. 25, 2024. The contents of that application are incorporated by reference herein.

### BACKGROUND

This disclosure relates generally to technology for computerized processing of patient medical images.

### SUMMARY

Enrollment of patients with target-positive tumors is thought to be a factor of success in CD3-redirection (and/or other effector-redirection) targeted therapy trials. This process can incur significant testing costs for assays like immunohistochemistry (IHC) target expression assessment and requires laborious pathologist scoring. Therefore, a need exists to efficiently select patient tumors for further analysis. Computerized inference via deep-learning models can potentially help. However, development of such models typically requires a large collection of whole tissue sections (WTS) and associated whole slide images (WSI), which can be challenging to score, and may not be available in early clinical studies.

Tissue microarrays (TMAs) can incorporate hundreds of cases on a single slide and are readily available through commercial vendors, reducing the number of slides needed for model development. TMA cores are typically orders of magnitude smaller than WTS. Embodiments of the present disclosure provide models that are trained on TMA cores but can be deployed on WTS images.

Some embodiments of the present disclosure provide a machine-learning-based patient enrichment model that uses hematoxylin and eosin (H&E)-stained WTS images to infer ENPP3 expression and rule out LUAD and COAD patients unlikely to be ENPP3+. In some embodiments, a complementary model to infer H-scores from ENPP3 IHC-stained tissues as an alternative to human scoring is provided to help reduce pathologist workload.

In some embodiments, TMA preprocessing aligns paired serial H&E and IHC core images with their associated metadata and H-scores. Some embodiments leverage a vision transformer (ViT) foundation model encoder that is pre-trained on 55,000 H&E WTS spanning tissue types using a self-supervised learning (SSL) objective (e.g., DINOv2 or DINOv1). In some embodiments, other encoders (e.g., a ResNet) can be used with other SSL objectives (e.g., SimCLR). In some embodiments, this endows the SSL pre-trained encoder with strong histopathology priors. In some embodiments, an SSL pre-trained encoder is trained on IHC-stained images. In some embodiments, the SSL pre-trained encoder is, after pre-training, used to generate patch-level embeddings from TMA core images associated with corresponding labels that are then used to train an attention-based deep learning network to generate inferences (e.g., regressing inferences and/or classification inferences). In one example, the attention-based deep learning network infers whether an H&E stained core's paired IHC-stained core has an ENPP3 H-score that is greater than zero for patient enrichment. In another example, the attention-based deep learning network infers an IHC-stained core's H-score directly via regression inference.

These and other aspects of and variations on the present disclosure are more fully detailed below.

### BRIEF DESCRIPTION OF THE DRAWINGS

FIG. 1 illustrates a deep-learning network being trained using tissue microarray (TMA) digital histopathology images to process whole slide images (WSIs) and other non-TMA digital histopathology images in accordance with an embodiment of the disclosure.

FIG. 2 illustrates a deep learning network for processing digital histopathology images that has been trained in accordance with the deep learning network of FIG. 1, for example.

FIG. 3 is a schematic diagram illustrating adjacent sections of a tissue microarray (TMA) used for training a deep learning network such as, for example, the deep learning network of FIG. 1.

FIG. 4 is a flow diagram illustrating a method for training a digital histopathology deep learning network, such as, for example, the deep learning network of FIGS. 1 and 2. The illustrated method is in accordance with an embodiment of the disclosure.

FIG. 5 is a flow diagram illustrating a method for generating inferences using a digital histopathology deep learning network, such as, for example, the deep learning network of FIGS. 1 and 2. The illustrated method is in accordance with an embodiment of the disclosure.

FIG. 6 illustrates example digital histopathology images including a heat map in accordance with an embodiment of the disclosure.

FIG. 7 shows an example of a computer system one or more of which may be used to implement one or more of the apparatuses, systems, and methods illustrated herein.

While the embodiments are described with reference to the above drawings, the drawings are intended to be illustrative, and other embodiments are consistent with the spirit, and within the scope, of the disclosure.

### DETAILED DESCRIPTION

The various embodiments now will be described more fully hereinafter with reference to the accompanying drawings, which form a part hereof, and which show, by way of illustration, specific examples of practicing the embodiments. This specification may, however, be embodied in many different forms and should not be construed as limited to the embodiments set forth herein; rather, these embodiments are provided so that this specification will be thorough and complete, and will fully convey the scope of the disclosure to those skilled in the art. Among other things, this specification may be embodied as methods or devices. Accordingly, any of the various embodiments herein may take the form of an entirely hardware embodiment, an entirely software embodiment or an embodiment combining software and hardware aspects. The following specification is, therefore, not to be taken in a limiting sense.

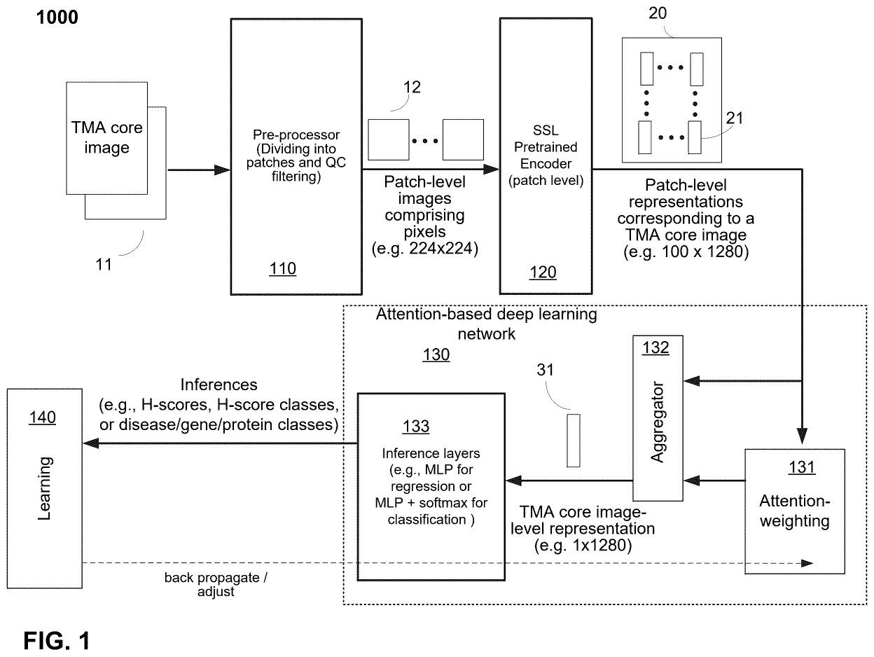

FIG. 1 illustrates a deep-learning network 1000 for processing digital histopathology images such as, for example, tissue microarray (TMA) core image 11. In digital histopathology, an image of a whole sample of biological tissue from a patient is generally referred to simply as a “whole slide image” (WSI) or “whole tissue section” (WTS) image, which may comprise a section of patient tissue that is prepared on a slide. Tissue microarrays (TMAs), on the other hand, are prepared from and composed of multiple patient tissue samples, and generally display much smaller tissue areas per patient case compared to a routine WSI. The smaller area can help reduce the variability of selecting an area for analysis and can help reduce the time it takes to find the area for analysis.

In the example shown in FIG. 1, system 1000 is being trained and fine-tuned for end-use in generating predictions or otherwise making inferences relevant to a particular task relevant to a tissue in a digital histopathology image such as, for example, inferring an H-score, inferring an H-score category, inferring presence of a particular gene or protein, inferring presence of a particular type of cancer or other disease, or other tasks. In the present example, a patch-level encoder 120 has been pretrained for extracting relevant features using a self-supervised learning (SSL) technique (also known in the art as an “objective.”). In one example, patch-level encoder 120 is pretrained on 55,000 WSIs spanning various tissue and tumor types, which endows the model with strong histopathology image knowledge.

In one embodiment, a pre-trained encoder 120 is a Vision Transformer (ViT). ViTs and ViT encoders are described, for example, in Dosovitskly et al. “An Image is Worth 16×16 Words”, 2021, hereby incorporated by reference herein. Various examples of particular encoder architectures and pre-training objectives that can be usefully applied to histopathology images is described in Applicant's co-pending international patent application PCT/IB2024/051739, filed on Feb. 22, 2024 (published Aug. 29, 2024 as WO 2024/176176) (“PCT '739 application”), also incorporated herein by reference in its entirety.

In one example, pre-processing block 110 receives TMA core image 11 (e.g., digital data corresponding to an image of a single TMA core of H&E-stained tissue on a histopathology slide, the tissue corresponding to a sample taken from a patient) and conducts pre-processing including dividing TMA core image 11 into patches. In one, non-limiting example, TMA core image 11 is divided into patches, each patch being a selected number of pixels. In this example, each image 11 is divided into 100 patches with each patch being 224×224 pixels in size. The number of patches in a TMA core image can depend on the size of the TMA core image and can therefore vary across a set of TMA core images.

WSIs and TMA core images are known to have various types of artifacts ranging from large amounts of background to pen marks, blurred areas, and bubbles. In one embodiment, pre-processing block 110 uses HistoQC (https://github.com/choosehappy/HistoQC/wiki), an open-source quality control tool for digital histopathology, to extract tissue patches 224×224 in size from a TMA core image 11. Each patch is processed through the tool, and it sequentially produces metrics and tracks the amount of background in the TMA images and the locations of pen marks. In one example, based on these metrics, pre-processing block 110 filters out patches containing artifacts and selects patches in the image with rich features.

Pre-processing block 110 outputs patch-level digital images 12. In one example, patch-level images 12 are 224×224 pixels in size. SSL pretrained patch level encoder 120 processes each patch image 12 to generate a patch-level representation 21. In one example, patch-level representations 21 are vectors having 1280 dimensions. Thus, in this example, the resulting representational data of each patch-level representation 21 is of size 1×1280, which consumes significantly less memory than the 224×224 pixel data of a patch 12. Of course, one skilled in the art will appreciate that the dimension size will depend on the type of encoder used and its configuration for a particular application. Therefore, the dimensions given for this embodiment are by way of example only.

In some example embodiments, several self-supervised learning (SSL) approaches for pretraining a patch-level encoder, such as, for example, SSL pretrained encoder 120 of the embodiment of FIG. 1, are known to those skilled in the art. In some embodiments, a ViT encoder is used and is trained using a “DINOv2” objective, as described by Oquab et al. in “DINOv2: Learning Robust Visual Features without Supervision” (2023) (arXiv:2304.07193). In some embodiments, a residual convolutional neural network (ResNet) encoder and a “SimCLR” SSL approach can be used, as described by Chen et al. in “A Simple Framework for Contrastive Learning of Visual Representations” (2020) (arXiv:2002.05709). In some embodiments, a ViT masked auto encoder (ViTMAE) approach may be used, as described by He, K., et al. in “Masked Autoencoders Are Scalable Vision Learners” (2021) (arXiv:2111.06377). In other embodiments, a “DINOv1” approach may be used, as described by Caron et al. in “Emerging Properties in Self-Supervised Vision Transformers” (2021) (arXiv:2104.14294). All four papers are hereby incorporated by reference in their entirety.

Patch-level representations 21 are used to represent each patch in a TMA core image, and a group 20 of patch-level representations 21 corresponding to a same TMA core image may be referred to as a TMA core pseudo image 20. Images 20 are referred to as “pseudo” images (or representational images) because the patches of the TMA core image are not expressed in pixel-space but rather are representations in a space whose dimensions are defined by SSL pretrained patch-level encoder 120. In one example, each TMA core pseudo-image 20 comprises 100 patch-level representations 21, and, therefore, TMA core pseudo images 20 are 100×1280 in size.

Patch-level representations 21 corresponding to a TMA core pseudo image 20 are processed by attention-based deep learning network 130. In one embodiment, attention-based deep learning network 130 comprises attention-weighting block 131, aggregator 132, and inference layers 133. An example of an attention weighting mechanism 131 used in attention-based deep learning network 130 comprises a two-layered neural network and is described by Ilse et al. in “Attention-based Deep Multiple Instance Learning” (28 Jun 2018) (arXiv:1802.04712v4 [cs.LG]). This paper is incorporated by reference herein in its entirety. Aggregator 132 generates a TMA core image-level representation 31. Representation 31 processed by an inference network 133 which in one example may include one or more typical feed-forward hidden layers (i.e., a multi-layer perceptron or “MLP”) to obtain a regression inference (e.g., H-score) or an MLP followed by a softmax layer to obtain classification inferences (e.g., class probabilities that the imaged tissue falls within one or more particular disease/gene/protein classes, or a particular H-score class) classifying the tissue corresponding to the relevant TMA core image 11 processed by system 1000.

During training, inferences are sent to learning block 140 where the inferences are compared with ground truth values for each TMA core image 11 to compute loss values. In one embodiment, learning block 140 computes a cross-entropy loss value. However, other loss values may be used. Computed loss values are back propagated through inference layers 133 and the attention-weighting mechanism 131 to adjust learnable parameters such as MLP weights in inference layers 133 and attention weights in attention-weighting block 131. In other words, the attention-based deep learning network 130 is trained using supervised learning. In some alternative embodiments, a computed loss can be back propagated further to adjust parameters in SSL pretrained encoder 120 during end-to-end supervised learning.

In other embodiments in accordance with the present disclosure, attention-based deep learning networks with different architectures than that shown for attention-based deep learning network 130 in FIG. 1. In one alternative, an additional encoder such as a ResNet is included in the data path prior to attention weighting block 131 and aggregator 132. In such an embodiment, learnable parameters of such an encoder can be adjusted during supervised learning or during weakly supervised learning, along with adjustment of learnable parameters in inference layers 133 and attention-weighting block 131. In yet another alternative embodiment, a ViT encoder can be used in place of attention-weighting block 131 and aggregator 132 and learnable parameters of such an encoder can be adjusted during supervised learning or during weakly supervised learning.

In some alternative embodiments, SSL pretraining of multiple encoders can be carried out in a hierarchical arrangement. An example of hierarchical pretraining of vision transformer (ViT) encoders for histopathology images is described by Chen et al. in “Scaling Vision Transformers to Gigapixel Images via Hierarchical Self-Supervised Learning” (2022) (arXiv:2206.02647). This paper is incorporated by reference herein in its entirety. In one example, a first SSL pre-trained encoder is used to generate patch-level representations from patch-level pixel data and those patch-level representations can be grouped together into region-level pseudo images and a second SSL pre-trained encoder can process region-level pseudo images to generate region-level representations which can then be processed by a downstream attention-based deep learning network. Such an approach is described in Applicant's co-pending PCT '739 application cited and incorporated by reference above.

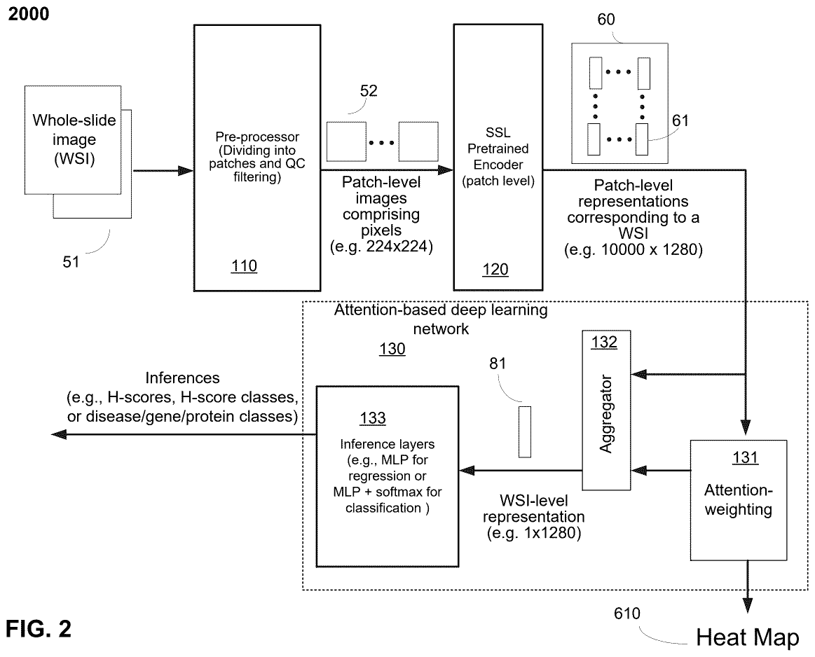

FIG. 2 illustrates a deep learning network 2000 that has been trained for end-use in generating inferences relevant to a tissue in a digital histopathology image such as, for example, inferring an H-score, inferring an H-score category, inferring present of a particular gene or protein, inferring presence of a particular type of cancer, or other tasks.

In general, elements in FIG. 2 with like numbers to elements shown in FIG. 1 operate in a similar manner except that, in FIG. 2, WSIs are processed through the network rather than TMA core images.

Pre-processing block 110 receives WSI 51 (e.g., digital data corresponding to an image of a single whole tissue slide (WTS) of H&E-stained tissue on a histopathology slide, the tissue corresponding to a sample taken from a patient) and conducts pre-processing including dividing WSI 51 into patches and performing quality control filtering in a manner previously described in the context of FIG. 1.

In one, non-limiting example, WSI 51 is divided into patches, each patch being 224×224 pixels in size. In this example, each image 51 is divided into approximately 10,000 patches with each patch being 224×224 pixels in size. The number of patches in a WSI will depend on the size of the WSI and can be expected to vary across a set of WSIs.

Pre-processing block 110 outputs patch-level digital images 52. In one example, patch-level images 52 are 224×224 pixels in size. SSL pretrained patch level encoder 120 processes each patch image 52 to generate a patch-level representation 61. In one example, patch-level representations 61 are vectors having 1280 dimensions. Thus, in this example, the resulting representational data of each patch-level representation 61 is of size 1×1280, which consumes significantly less memory than the 224×224 pixel data of a patch 52. Of course, one skilled in the art will appreciate that the dimension size will depend on the type of encoder used and its configuration for a particular application. Therefore, the dimensions given for this embodiment are by way of example only.

Patch-level representations 61 are used to represent each patch in a TMA core image, thereby providing WSI pseudo images 60. In one example, each WSI image comprises 10000 patches, and, therefore, WSI pseudo images 60 are 10000×1280 in size.

Patch-level representations 61 corresponding to a WSI pseudo image 60 are processed by attention-based deep learning network 130. The illustrated embodiment of attention-based deep learning network 130 is as described in FIG. 1, and alternatives to that embodiment are also as described in the context of FIG. 1. However, in FIG. 2, attention-based deep learning network 130 is operating on representations of patches of a WSI rather than of a TMA core image. Attention-weighting block 131 applies learned weights to patch-level representations 61 of a WSI pseudo image 60. Aggregator 132 then generates a single WSI-level representation 81 of WSI 51. In this example, representation 81 may have dimensions of 1×1280. Representation 81 is then processed by inference layers 133 which in one example may include one or more typical feed-forward hidden layers (i.e., a multi-layer perceptron or “MLP”) to obtain one or more inferences. In one example, inference layers 133 comprise an MLP that generates a regression value to infer an H-score, which is a value between 0 and 300, corresponding to tissue in the WSI. In one example, the H-score is relevant to inferring expression of the ENPP3 gene. In another example, an MLP is followed by a softmax layer and is used to obtain classification inferences such as, for example, class probabilities that the imaged tissue falls within one or more particular disease/gene/protein classes, or a particular H-score class, such as H-score=0 or H-score>0.

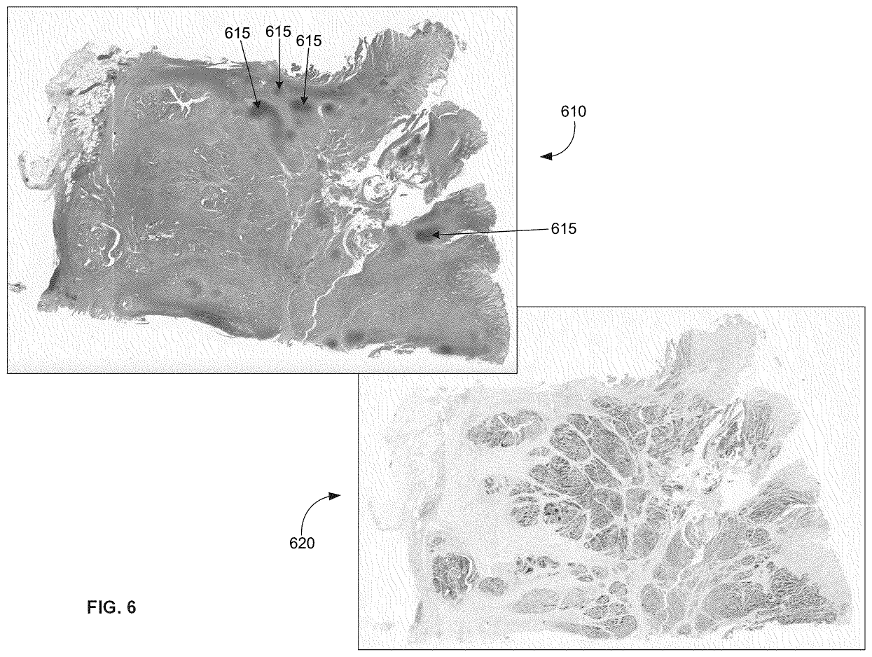

Attention-weighting mechanism 131 can also be used to generate a heat map 71 of WSI 51 using WSI patch-level representations 61 of pseudo image 60 to show areas of particular interest. An example of a heat map 610 is illustrated in FIG. 6.

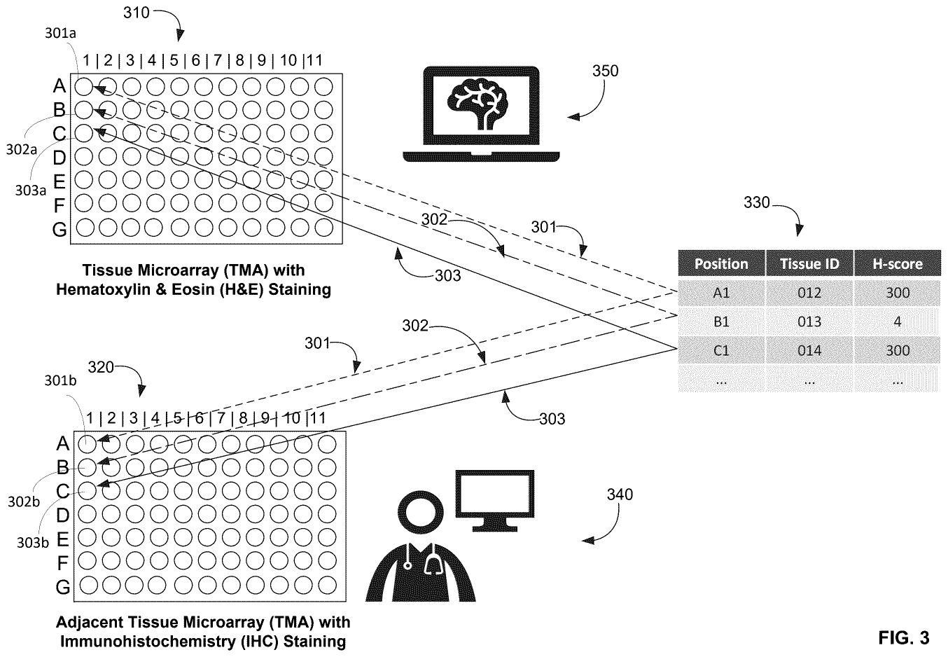

FIG. 3 is a schematic diagram illustrating TMA 310 and adjacent-tissue TMA 320. In this example, TMA 310 comprises a plurality of core sections that are each taken from tissue serial to a corresponding core section on TMA 320. In some examples, a single TMA slide can be prepared with a formalin-fixed, paraffin-embedded (FFPE) section of various tissue samples (e.g., of human tumors), where each sample may be from a TMA core (e.g., cores 301, 302, and 303) and assembled in a grid pattern as shown in TMA 310 and 320 of FIG. 3.

Adjacent (serial) core sections of tissue can be prepared, each on a separate TMA slide. For example, as illustrated, core section 301a on TMA 310 and core section 301b on TMA 320 are serial sections of the same core 301. Similarly, core section 302a and 302b are serial sections of the same core 302 and core sections 303a and 303b are serial sections of the same core 303. In this example, cores 301, 302, and 303 have been assigned a unique tissue ID, and occupy grid positions A1, B1, and C1 respectively in TMAs 310 and 320 as shown in database 330.

Within the TMA, in some examples, each TMA core may comprise, e.g., tumor tissue that is represented by, e.g., a 0.6 mm core diameter sample, and there may be more than one TMA core from a given sample or human subject. Other sizes and shapes of core samples, and other assemblies of cores, can be contemplated within the scope of this disclosure. The adjacent TMA sections can be stained using any one of several tissue staining methods known to those skilled in the art, including immunohistochemistry (IHC) staining and hematoxylin and eosin (H&E) staining. In one embodiment, tissue core sections on TMA 310 are stained using a first staining method, such as H&E staining, and tissue core sections on TMA 320 are stained using a second staining method, such as IHC staining.

A human pathologist 340 analyzes core sections (or images of those sections) on TMA 320 and evaluates tissue cores 301, 302, and 303, to assign an H-score (and/or a classification, e.g., ENPP3 positive) to each core 301, 302, and 303. As shown, the pathologist-assigned H-scores are stored in database 330. The pathologist-assigned values of database 330 form ground truth values that are used in some examples as the labels for TMA core images of the H&E-stained core sections in TMA 310 for training deep learning network 350, as described above in FIG. 1.

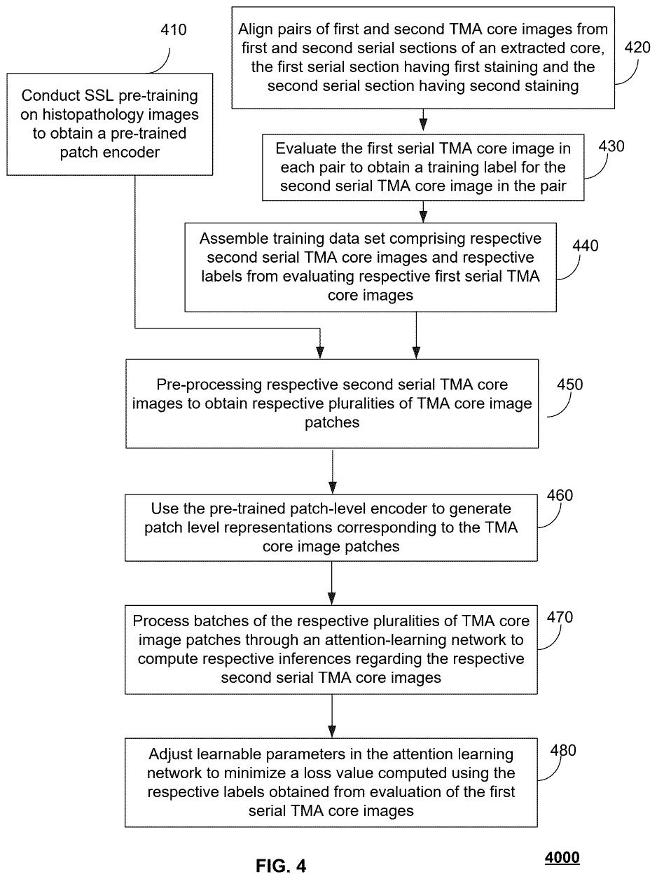

FIG. 4 is a flow diagram illustrating a method 4000 for training a digital histopathology deep learning network, such as, for example, the deep learning network of FIGS. 1 and 2.

Step 410 conducts self-supervised learning on patch-level images to obtain a pre-trained patch level encoder. In some embodiments, a large training set of histopathology images is used at step 410. In some embodiments, the histopathology images in the training set are not task specific, but include a wide variety of tissue samples, e.g., from many diverse potential disease sites. In some examples, the self-supervised learning is conducted using a vision transformer foundation model pre-trained on approximately 55,000 H&E-stained whole tissue slides (WTS) spanning various tissue types. In other examples, over 11,677 H&E-stained whole slide images from TCGA public data can be used for pretraining. In one example, the training slides come from 33 diverse potential tumor sites. In one example, approximately 33 million patches of 224×224 pixels are extracted from the WSI training set and are used at step 410.

Steps 420, 430, and 440 can be performed before, after, or concurrently with step 410. Step 420 aligns pairs of first and second TMA core images from first and second serial sections of an extracted tissue core of the TMA, the first serial section having a first staining and the second serial section having a second staining that is different from the first staining. In some examples, the first and second serial sections comprise sequential slices of an extracted tissue core of the TMA, which comprises multiple tissue cores arranged in a grid format as described above in conjunction with FIG. 3. In some embodiments, the second staining is done using immunohistochemistry (IHC) staining and the first staining is done using H&E staining. Step 430 then evaluates the second serial TMA core (or an image of that core) in each pair to obtain a training label for the first serial TMA core image in the pair. In some embodiments, an expert (e.g., a trained pathologist) completes the evaluation of the second serial TMA core image and assigns the image a classification (e.g., a H-score class, or a disease/gene/protein class), or a value (e.g., an H-score). This classification or value can be used as a training label for the first serial TMA core image in the pair. Step 440 then assembles a training data set comprising the respective first serial TMA core images with the respective labels obtained from evaluating the corresponding respective second serial TMA core images.

Step 450 pre-processes the respective first serial TMA core images to obtain respective pluralities of TMA core image patches. As discussed above with respect to FIG. 1, pre-processing divides a TMA core image into a plurality of patches of a predetermined size and performs quality control (QC) filtering to remove artifacts in the core image. In one example, each TMA core image is divided into approximately 100 patches, and each patch is of size 224 pixels×224 pixels.

Step 460 uses the pre-trained patch-level encoder from step 410 to generate patch-level representations corresponding to the first serial TMA core image patches from step 450. The first serial TMA core image patches are training image patches (pixel data) that are encoded into patch-level representations. In one example, each patch-level representation is a vector representation comprising 1×1280 dimensions, so that each TMA core image has about 100 vectors each of size 1280, as discussed in conjunction with FIG. 1 above.

Step 470 processes batches of the respective pluralities of TMA core image patches through an attention learning network, such as that described with respect to attention-based deep learning network 130 in FIG. 1 above. In step 470, the attention learning network computes respective inferences regarding the respective first serial TMA core images.

After a batch is processed, step 480 adjusts learnable parameters in the attention learning network to minimize loss values computed using the respective labels obtained from evaluation of the second serial TMA core images. During training, the computed loss values are back propagated through the classifier layer or layers and the attention-weighting mechanism 131 shown in FIG. 1 to adjust the learnable parameters.

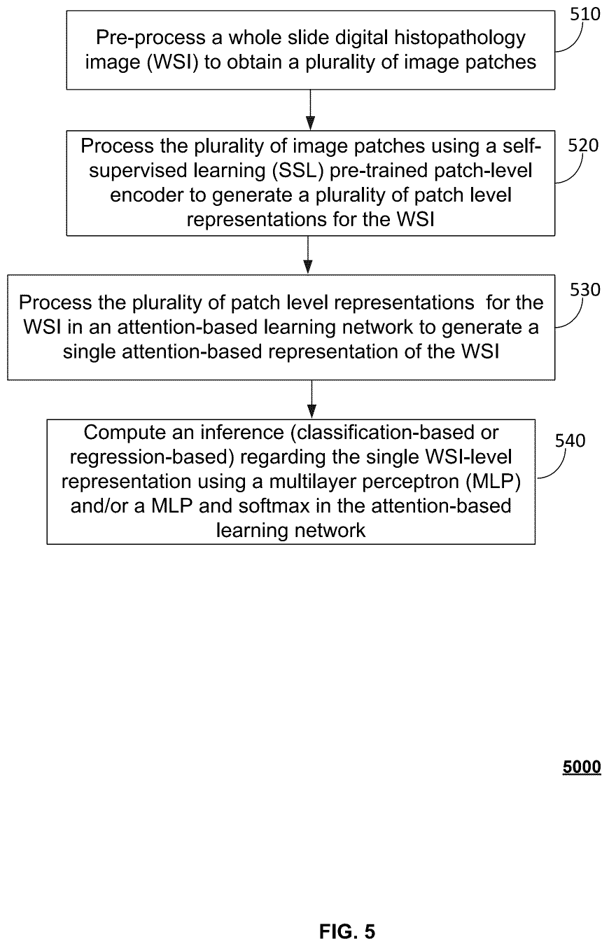

FIG. 5 is a flow diagram illustrating a method 5000 for generating inferences using a digital histopathology deep learning network, such as, for example, the deep learning network of FIG. 2. In some embodiments, method 5000 utilizes attention-based deep learning network 130 trained using TMA core images in accordance with method 4000 as discussed above. In some examples, method 5000 generates inferences for whole slide images (WSIs), comprising digital histopathology images of whole tissue sections (WTS). Method 5000 can, in some examples, also be used to generate inferences for tissue samples other than WSIs, such as TMA cores.

Step 510 pre-processes a whole slide image (WSI) to obtain a plurality of image patches, as discussed above with respect to FIG. 2.

Step 520 processes the plurality of patch-level images using a self-supervised learning (SSL) pre-trained patch level encoder to generate a plurality of patch-level representations (e.g., embeddings) for the WSI. In one example, only one level of SSL pre-trained encoder is used. However, in some examples, more than one pre-trained encoder may be used in a hierarchical fashion. For example, a patch-level encoder can be configured to compute a plurality of patch-level embeddings corresponding to the WSI, and a region-level encoder can be configured to process the plurality of patch-level embeddings to compute a plurality of region-level embeddings corresponding to the WSI. In some such hierarchical examples, an image region corresponds to a portion of an image that is at least 100 times larger than an image patch. In some examples, an image region corresponds to a portion of an image that is at least 200 times larger than an image patch. In some examples, an image region corresponds to a portion of an image that is at least 400 times larger than an image patch.

Step 530 processes the plurality of patch level representations for digital histopathology image (e.g., the WSI) in an attention-based learning network to generate a single attention-based representation of the WSI. In some examples, attention-based deep learning network 130 processes together the plurality of region-level embeddings corresponding to the WSI.

Step 540 computes an inference (classification-based or regression-based) regarding the single WSI-level representation using a multilayer perceptron (MLP) and/or a MLP and a softmax layer in the attention-based deep learning network 130 of FIG. 2.

In one example, an H&E-based COAD H-score>0 classification model consistent with techniques described herein obtained an AUC=0.79 on a held-out test set of 29 WTS. In one example, the IHC-based H-score regression models for COAD and LUAD achieved intraclass correlation coefficients of 0.76 and 0.88 on their respective held-out test sets (n=29 WTS for COAD and n=46 cores for LUAD).

FIG. 6 illustrates heat map 610 referenced above in the context of FIG. 2. In the illustrated example, heat map 610 comprises an H&E-stained WSI digital histopathology image, with high-attention patches 615 shown in red (or darker intensity) in contrast to the other parts of the H&E-stained digital histopathology image. In some examples, heat map 610 may be analyzed in conjunction with digital histopathology image of an adjacent section of the same tissue sample. For example, FIG. 6 shows a second WSI digital histopathology image 620 created using a second staining method, e.g., IHC staining. Second digital histopathology image 620 can be used in some examples for confirmatory screening by a human pathologist or other expert screening method, in conjunction with heat map 610 to focus on areas of interest (e.g., high-attention areas of tumor cells or activity). In one example, a computer user interface generates, on an electronic display, heat map 610 together with WSI 620 to facilitate review and analysis by a pathologist.

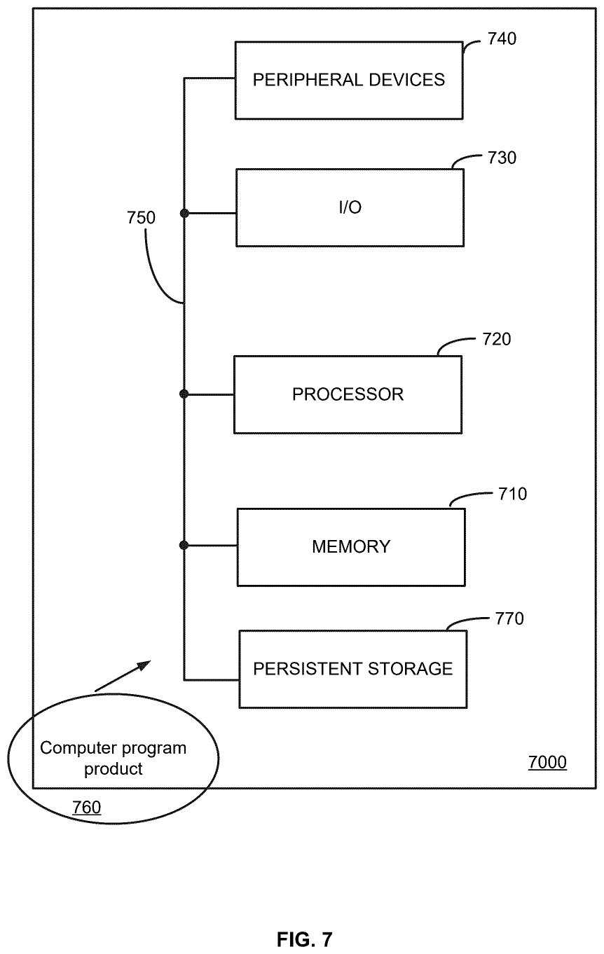

FIG. 7 shows an example of a computer system 7000, one or more of which may be used to implement one or more of the apparatuses, systems, and methods illustrated herein. Computer system 7000 executes instruction code contained in a computer program product 760. Computer program product 760 comprises executable code in an electronically readable medium that may instruct one or more computers such as computer system 7000 to perform processing that accomplishes the exemplary method steps performed.

The electronically readable medium may be any transitory or non-transitory medium that stores information electronically and may be accessed locally or remotely, for example via a network connection. The medium may include a plurality of geographically dispersed media each configured to store different parts of the executable code at different locations and/or at different times. The executable instruction code in an electronically readable medium directs the illustrated computer system 7000 to carry out various exemplary tasks described herein. The executable code for directing the carrying out of tasks described herein would be typically realized in software. However, it will be appreciated by those skilled in the art, that computers or other electronic devices might utilize code realized in hardware to perform many or all the identified tasks. Those skilled in the art will understand that many variations on executable code may be found that implement exemplary methods within the spirit and the scope of the disclosure.

The code or a copy of the code contained in computer program product 760 may reside in one or more storage persistent media (not separately shown) communicatively coupled to system 7000 for loading and storage in persistent storage device 770 and/or memory 710 for execution by processor 720. Computer system 7000 also includes I/O subsystem 730 and peripheral devices 740. I/O subsystem 730, peripheral devices 740, processor 720, memory 710, and persistent storage device 770 are coupled via bus 750. Like persistent storage device 770 and any other persistent storage that might contain computer program product 760, memory 710 is a non-transitory media (even if implemented as a typical volatile computer memory device). Moreover, those skilled in the art will appreciate that in addition to storing computer program product 760 for carrying out processing described herein, memory 710 and/or persistent storage device 770 may be configured to store the various data elements referenced and illustrated herein.

Those skilled in the art will appreciate computer system 7000 illustrates just one example of a system in which a computer program product in accordance with the disclosure may be implemented. To cite but one example, execution of instructions contained in a computer program product may be distributed over multiple computers, such as, for example, over the computers of a distributed computing network.

Instructions for implementing an artificial neural network or other deep learning network may reside in computer program product 760. When processor 720 is executing the instructions of computer program product 760, the instructions, or a portion thereof, are typically loaded into working memory 710 from which the instructions are readily accessed by processor 720.

Processor 720 may comprise multiple processors which may comprise respective additional working memories (additional processors and memories not individually illustrated) including one or more graphics processing units (GPUs) comprising at least thousands of arithmetic logic units supporting parallel computations on a large scale. GPUs are often utilized in deep learning applications because they can perform the relevant processing tasks more efficiently than can a typical general-purpose processors (CPUs). Processor 720 may additionally or alternatively comprise one or more specialized processing units comprising systolic arrays and/or other hardware arrangements that support efficient parallel processing. Such specialized hardware may work in conjunction with a CPU and/or GPU to carry out the various processing described herein. Such specialized hardware may comprise application specific integrated circuits and the like (which may refer to a portion of an integrated circuit that is application-specific), field programmable gate arrays and the like, or combinations thereof. However, a processor such as processor 720 may be implemented as one or more general purpose processors (preferably having multiple cores) without necessarily departing from the spirit and scope of the present disclosure.

### ADDITIONAL EXAMPLES

Example 1: A method of using respective tissue microarray (TMA) core images extracted from TMA images to train a deep learning network configured to execute on one or more computers to process histopathology images to generate inferences regarding tissue corresponding to the histopathology images, the method comprising: pre-processing respective TMA core images to obtain respective pluralities of image patches, the respective pluralities of image patches corresponding to respective first TMA core images of respective first core sections stained using a first staining; processing batches of the respective pluralities of image patches through the deep learning network to compute respective inferences regarding the respective first TMA core images; and after a batch is processed, adjusting learnable parameters in a least a portion of the deep learning network to minimize a loss value computed using respective label data corresponding to the respective first TMA core images of respective first core sections; wherein: the respective label data is obtained from evaluation of respective second TMA core images of respective second core sections that have been stained using a second staining that is different from the first staining.

Example 2: The method of example 1 wherein the second staining is immunohistochemistry (IHC) staining.

Example 3: The method of any of examples 1-2 wherein the first staining is hematoxylin and eosin (H&E) staining.

Example 4: The method of any of examples 1-3 wherein a respective first core section of the respective first core sections and a corresponding respective second core section of the respective second core sections comprise serial sections from a tissue core.

Example 5: The method of any of examples 1-4 wherein the deep learning network comprises: a pretrained encoder that has been pretrained using self-supervised learning, wherein the pre-trained encoder processes respective pluralities of patches corresponding to respective TMA core images to obtain respective pluralities of patch-level embeddings; and an attention-based deep-learning network configured to process together a respective plurality of patch-level embeddings corresponding to a respective TMA core image to obtain an inference regarding the respective core image.

Example 6: The method of example 5 wherein the pretrained encoder is a vision transformer (ViT) encoder.

Example 7: The method of example 6 wherein the ViT encoder has been pretrained using a DINOv2 objective.

Example 8: The method of example 5 wherein the pretrained encoder is a residual convolutional neural network (ResNet) that has been pre-trained using a SimCLR objective.

Example 9: The method of any of examples 5-8 wherein the attention-based deep-learning network comprises a vision transformer encoder (ViT) and a multilayer perceptron (MLP).

Example 10: The method any of examples 5-8 wherein the attention-based deep-learning network comprises: an attention block configured to apply respective weights to respective patch embeddings of the respective plurality of patch embeddings to obtain weighted patch embeddings and compute, from the weighted patch embeddings, a vector representation of the respective core image; and a multilayer perceptron configured to compute a respective inference from the vector representation of the respective core image.

Example 11: The method of any of examples 1-10 wherein the respective inferences are regression inferences.

Example 12: The method of example 11 wherein the respective inferences are H-scores.

Example 13: The method of any of examples 1-10 wherein the respective inferences are classifications.

Example 14: The method of example 13 wherein the classifications are H-score categories.

Example 15: The method of example 13 wherein the classifications are whether an H-score is greater than zero.

Example 16: The method of any of examples 1-15 wherein the evaluation of the respective second TMA core images of the respective second core sections that have been stained using the second staining is conducted by a human pathologist.

Example 17: A computerized deep-learning system comprising one or more computers configured to process digital histopathology images, the computerized deep-learning system comprising: one or more pre-trained encoders configured to process a plurality of patches obtained from a digital histopathology image to compute a plurality of embeddings corresponding to the digital histopathology image, wherein the one or more pre-trained encoders have been pretrained using self-supervised learning; and an attention-based deep learning network configured to process the plurality of embeddings corresponding to the digital histopathology image to generate an image-level embedding representing the digital histopathology image and to compute, using the image-level embedding, an inference regarding the digital histopathology image, wherein the attention-based learning network has been trained using tissue microarray (TMA) images.

Example 18: The computerized deep-learning system according to example 17wherein:
the digital histopathology image is a whole slide image (WSI).

Example 19: The computerized deep-learning system according to any of examples 17-18 wherein the attention-based learning network has been trained using label data obtained from evaluation of TMA cores that have been stained using a second staining that is different from a first staining used to stain tissue corresponding the digital histopathology image regarding which the inference is computed.

Example 20: The computerized deep-learning system of example 19 wherein the attention-based deep learning network is further configured to: based on the plurality of embeddings, the image level embedding, or the inference, identify one or more areas on the digital histopathology image associated with the inference; and provide attention data to a user-interface module configured to display a heat map on a graphical interface of a user device, wherein the heat map comprises the digital histopathology image including markers identifying the one or more areas.

Example 21: The computerized deep-learning system of example 20, wherein the digital histopathology image comprises a first whole tissue section (WTS) image stained using the first staining, and the user-interface module is further configured display a digital histopathology image comprising a second WTS image stained using the second staining, wherein the first and second WTS images comprise serial sections of a tissue sample.

Example 22: The computerized deep-learning system of example 17 wherein: the attention-based deep learning network is further configured to provide attention data to a user-interface module, the attention data being relevant to an inference generated by the attention-based deep learning network regarding a tissue sample; and the user-interface module is configured to generate a graphical user interface display of a histopathology image of the tissue sample overlaid with a representation of the attention data that identifies one or more high-attention areas of the histopathology image.

Example 23: The computerized deep-learning system of any of examples 19-22 wherein the second staining is immunohistochemistry (IHC) staining.

Example 24: The computerized deep-learning system of any of examples 19-23 wherein the first staining is hematoxylin and eosin (H&E) staining.

Example 25: The computerized deep-learning system of any of examples 17-24 wherein the inference comprises a regression inference.

Example 26: The computerized deep-learning system of example 25 wherein the regression inference comprises an H-score.

Example 27: The computerized deep-learning system of any of examples 17-24 wherein the inference comprises a classification.

Example 27: The computerized deep-learning system of example 27 wherein the classification comprises an H-score category.

Example 29: The computerized deep-learning system of example 27 wherein the classification comprises whether an H-score is zero or greater than zero.

Example 30: The computerized deep-learning system of any of examples 17-29 wherein the inference is used to infer ENPP3 expression.

Example 31: The computerized deep-learning system of example 18 wherein the one or more pre-trained encoders comprise a patch-level encoder and a region-level encoder; the patch-level encoder is configured to compute a plurality of patch-level embeddings corresponding to the WSI; the region-level encoder is configured to process the plurality of patch-level embeddings to compute a plurality of region-level embeddings corresponding to the WSI; and the attention-based deep learning network is configured to process together the plurality of region-level embeddings corresponding to the digital histopathology image to compute the inference regarding the digital histopathology image.

While the present disclosure has been particularly described with respect to the illustrated embodiments, it will be appreciated that various alterations, modifications, and adaptations may be made based on the disclosure and are intended to be within the scope of the disclosure. While the disclosure has been described in connection with what are presently considered to be the most practical and preferred embodiments, it is to be understood that the present disclosure is not limited to the disclosed embodiments but, on the contrary, is intended to cover various modifications and equivalent arrangements included within the scope of the underlying principles as described by the various embodiments reference above and below.

1. A method of using respective tissue microarray (TMA) core images extracted from TMA images to train a deep learning network configured to execute on one or more computers to process histopathology images to generate inferences regarding tissue corresponding to the histopathology images, the method comprising:
pre-processing respective TMA core images to obtain respective pluralities of image patches, the respective pluralities of image patches corresponding to respective first TMA core images of respective first core sections stained using a first staining;
processing batches of the respective pluralities of image patches through the deep learning network to compute respective inferences regarding the respective first TMA core images; and
after a batch is processed, adjusting learnable parameters in a least a portion of the deep learning network to minimize a loss value computed using respective label data corresponding to the respective first TMA core images of respective first core sections; wherein:
the respective label data is obtained from evaluation of respective second TMA core images of respective second core sections that have been stained using a second staining that is different from the first staining.

2. The method of claim 1 wherein the second staining is immunohistochemistry (IHC) staining.

3. The method of claim 1 wherein the first staining is hematoxylin and eosin (H&E) staining.

4. The method of claim 1 wherein a respective first core section of the respective first core sections and a corresponding respective second core section of the respective second core sections comprise serial sections from a tissue core.

5. The method of claim 1 wherein the deep learning network comprises:
a pretrained encoder that has been pretrained using self-supervised learning, wherein the pre-trained encoder processes respective pluralities of patches corresponding to respective TMA core images to obtain respective pluralities of patch-level embeddings; and
an attention-based deep-learning network configured to process together a respective plurality of patch-level embeddings corresponding to a respective TMA core image to obtain an inference regarding the respective core image.

6. The method of claim 5 wherein the pretrained encoder is a vision transformer (ViT) encoder.

7. The method of claim 5 wherein the attention-based deep-learning network comprises a vision transformer encoder (ViT) and a multilayer perceptron (MLP).

8. The method claim 5 wherein the attention-based deep-learning network comprises:
an attention block configured to apply respective weights to respective patch embeddings of the respective plurality of patch embeddings to obtain weighted patch embeddings and compute, from the weighted patch embeddings, a vector representation of the respective core image; and
a multilayer perceptron configured to compute a respective inference from the vector representation of the respective core image.

9. The method of claim 1 wherein the respective inferences comprise at least one of a regression and a classification.

10. The method of claim 9 wherein the respective inferences comprise at least one of an H-score and an H-score category.

11. A computerized deep-learning system comprising one or more computers configured to process digital histopathology images, the computerized deep-learning system comprising:
one or more pre-trained encoders configured to process a plurality of patches obtained from a digital histopathology image to compute a plurality of embeddings corresponding to the digital histopathology image, wherein the one or more pre-trained encoders have been pretrained using self-supervised learning; and
an attention-based deep learning network configured to process the plurality of embeddings corresponding to the digital histopathology image to generate an image-level embedding representing the digital histopathology image and to compute, using the image-level embedding, an inference regarding the digital histopathology image, wherein the attention-based learning network has been trained using tissue microarray (TMA) images.

12. The computerized deep-learning system according to claim 11 wherein:
the digital histopathology image is a whole slide image (WSI).

13. The computerized deep-learning system according to claim 11 wherein the attention-based learning network has been trained using label data obtained from evaluation of TMA cores that have been stained using a second staining that is different from a first staining used to stain tissue corresponding the digital histopathology image regarding which the inference is computed.

14. The computerized deep-learning system of claim 13 wherein the attention-based deep learning network is further configured to:
based on the plurality of embeddings, the image level embedding, or the inference, identify one or more areas on the digital histopathology image associated with the inference; and
provide attention data to a user-interface module configured to display a heat map on a graphical interface of a user device, wherein the heat map comprises the digital histopathology image including markers identifying the one or more areas.

15. The computerized deep-learning system of claim 14, wherein the digital histopathology image comprises a first whole tissue section (WTS) image stained using the first staining, and the user-interface module is further configured display a digital histopathology image comprising a second WTS image stained using the second staining, wherein the first and second WTS images comprise serial sections of a tissue sample.

16. The computerized deep-learning system of claim 11 wherein:
the attention-based deep learning network is further configured to provide attention data to a user-interface module, the attention data being relevant to an inference generated by the attention-based deep learning network regarding a tissue sample; and
the user-interface module is configured to generate a graphical user interface display of a histopathology image of the tissue sample overlaid with a representation of the attention data that identifies one or more high-attention areas of the histopathology image.

17. The computerized deep-learning system of claim 13 wherein the second staining is immunohistochemistry (IHC) staining.

18. The computerized deep-learning system of claim 13 wherein the first staining is hematoxylin and eosin (H&E) staining.

19. The computerized deep-learning system of claim 11 wherein the inference comprises at least one of: a regression and a classification.

20. The computerized deep-learning system of claim 11 wherein the inference comprises at least one of: an H-score and an H-score category.

21. The computerized deep-learning system of claim 15 wherein the inference is used to infer ENPP3 expression.

22. The computerized deep-learning system of claim 12 wherein the one or more pre-trained encoders comprise a patch-level encoder and a region-level encoder;
the patch-level encoder is configured to compute a plurality of patch-level embeddings corresponding to the WSI;
the region-level encoder is configured to process the plurality of patch-level embeddings to compute a plurality of region-level embeddings corresponding to the WSI; and
the attention-based deep learning network is configured to process together the plurality of region-level embeddings corresponding to the digital histopathology image to compute the inference regarding the digital histopathology image.

23. A computerized deep-learning system comprising one or more computers configured to process digital histopathology images, the computerized deep-learning system comprising:
one or more encoders configured to process a plurality of patches obtained from a digital histopathology image to compute a plurality of embeddings corresponding to the digital histopathology image; and
an attention-based deep learning network configured to process the plurality of embeddings corresponding to the digital histopathology image to generate an image-level embedding representing the digital histopathology image and to compute, using the image-level embedding, an inference regarding the digital histopathology image, wherein the attention-based learning network has been trained using tissue microarray (TMA) images and label data obtained from evaluation of TMA cores that have been stained using a second staining that is different from a first staining used to stain tissue corresponding the digital histopathology image regarding which the inference is computed.
